(19) United States
(12) Patent Application Publication
(10) Pub. No.: US 2008/0140498 A1
(43) Pub. Date: Jun. 12, 2008

(54) MANAGING SCHEDULES USING SHARED WEB CALENDARS

(75) Inventors: Rajesh SETTY, Sunnyvale, CA (US); Hariprasad R. SHETTY, Campbell, CA (US)

Correspondence Address: SUGHRUE MION, PLLC, 2100 PENNSYLVANIA AVENUE, N.W., SUITE 800, WASHINGTON, DC, 20037, US

(73) Assignee: IPOLIPO, INC, Bethany, CT (US)

(21) Appl. No.: 11/948,353

(22) Filed: Nov. 30, 2007

Related U.S. Application Data
(60) Provisional application No. 60/861,961, filed on Dec. 1, 2006.

(51) Int. Cl. G06Q 10/00

(52) U.S. Cl. 705/9

(57) ABSTRACT

A method of managing schedules using shared web calendars is disclosed. In an embodiment, the method includes publishing an availability status of a user in a web calendar and selectively sharing portions of the web calendar with one or more recipients. The method also includes proposing schedules for one or more events based on the availability status of the user in the web calendar.

This Application claims benefit from co-pending US Provisional Application: 60/861,961, filed on Dec. 1, 2006, the contents of which are incorporated herein by reference.

### BACKGROUND

All business processes, whether big or small, usually include managing schedules for events, such as, meetings, conferences, interviews, appointments, etc. Typically, a schedule for an event may be managed by way of exchanging electronic mails between one or more participants of the event. Such electronic mails usually include schedule details, for example, a meeting request with proposed venue and time details, etc. A recipient of the mail may reply to the mail to either accept the request or to request for a different schedule with a change in the schedule details. Such exchange of electronic mails to arrive at a final schedule for the event may be time consuming which may be unacceptable in certain scenarios.

Existing systems and methods manage schedules by sharing a user's calendar with one or more recipients. The recipients can view schedule details of all the events that are scheduled for the user during a particular day or a week. Such sharing of data (e.g. schedule details for all events) may be undesirable for various reasons like, confidentiality.

### SUMMARY

This summary is provided to introduce systems and methods for managing schedules using a shared web calendar, which is further described below in the Detailed Description. This summary is not intended to identify essential features of the claimed subject matter, nor is it intended for use in determining the scope of the claimed subject matter.

In one embodiment, the method includes publishing an availability status of a user in a web calendar. The method further includes sharing the web calendar with one or more recipients such that each of the recipients views a selected portion of the availability status in the web calendar.

### BRIEF DESCRIPTION OF THE FIGURES

The detailed description is described with reference to the accompanying figures.

FIG. 1 illustrates an exemplary system for managing schedules using shared web calendars.

FIG. 2 illustrates an exemplary user device for managing schedules using web calendars according to an embodiment.

FIG. 3 illustrates an exemplary application database and a web based application in an implementation.

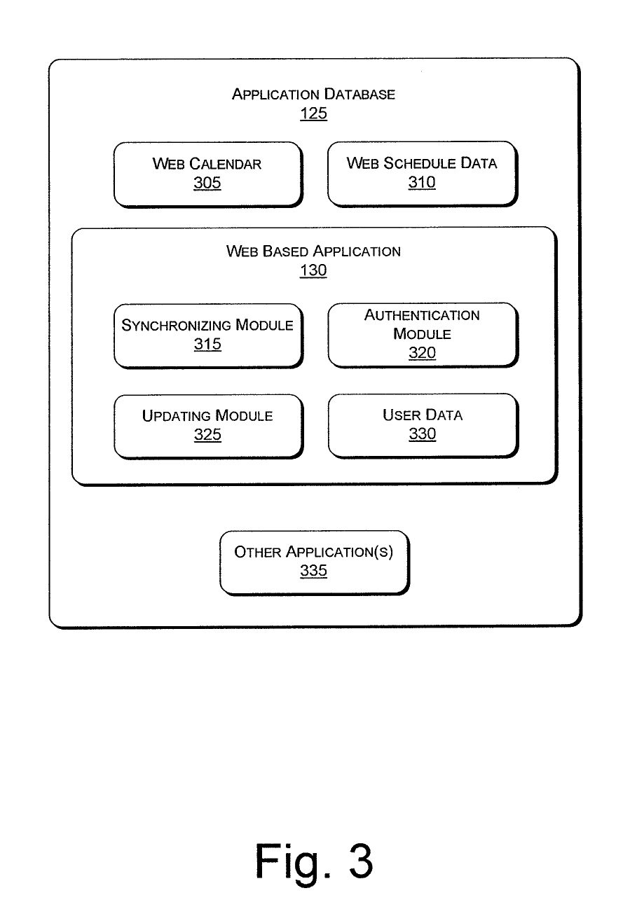

FIG. 4 illustrates an exemplary method for managing schedules using shared web calendars in an embodiment.

FIG. 5 illustrates a series of exemplary interactions with a web server in an embodiment.

FIG. 6 illustrates an exemplary method for managing a schedule for an event between a user and a client using a shared web calendar.

### DETAILED DESCRIPTION

The following disclosure describes systems and methods for managing schedules using shared web calendars. While aspects of described systems and methods for managing schedules using shared web calendars can be implemented in any number of different computing systems, environments, and/or configurations, implementations of systems and methods are described in the context of the following exemplary system architecture(s).

In a typical scenario, it may be desirable for a user to provide one or more individuals with an availability status of the user (availability information in a day or a week) to facilitate scheduling of an event, for example, a meeting, a conference, etc. The user may choose to provide such availability status based on a need-to-know basis. To substantiate, the user may selectively share the availability status with a group or an individual depending upon one or more events associated with the group or the individual. Systems and methods are disclosed that enable the user to selectively share portions of a web calendar with one or more recipients. In an implementation, the user publishes the availability status (e.g., date and, time) in the web calendar and shares portions of the web calendar with one or more recipients. A recipient may be a group of individuals or an individual, associated with one or more events, defined by the user for the purpose of sharing the availability status.

A recipient receives the web calendar that represents the user's availability status meant for the recipient. In an embodiment, the recipient selects a particular day and time (schedule details) for a given event in the web calendar and proposes a schedule by sending a schedule request to the user suggesting a schedule for the event. The user, upon receiving the schedule request, may either accept or reject the proposed schedule.

### An Exemplary System

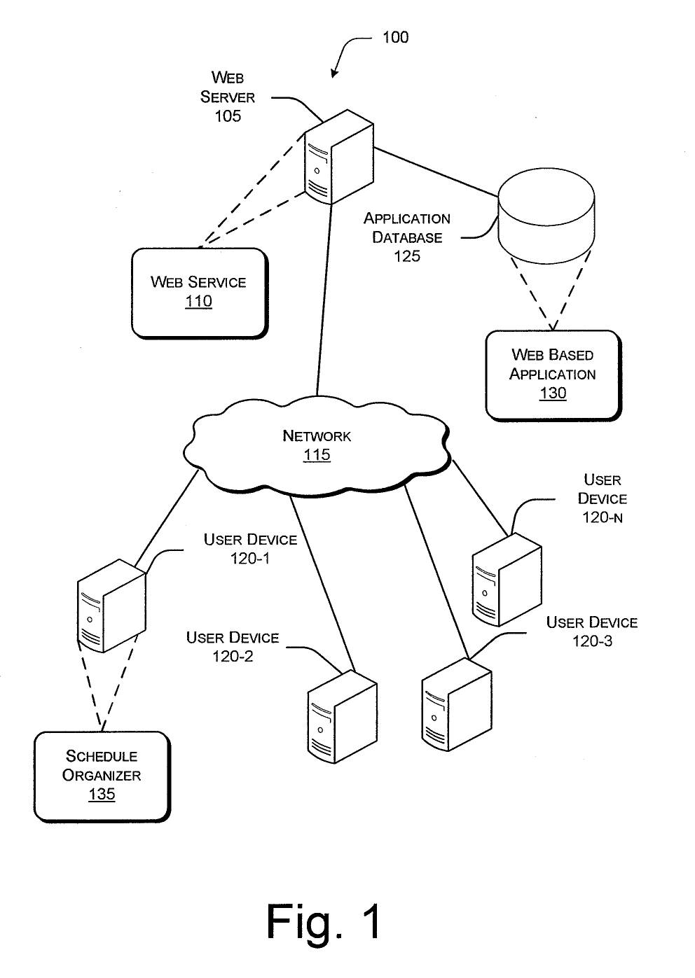

FIG. 1 shows an exemplary system 100 for managing schedules using shared web calendars. Accordingly, the system 100 includes a web server 105 associated with a web service 110 to facilitate interoperable machine-to-machine interaction over a network 115. The web server 105 may be implemented in many ways including, for example, as a stand alone general purpose computing device or as a cluster of servers (e.g., arranged in a server farm). The web service 110 includes a standard means of interoperating between different software applications, running on a variety of platforms and/or frameworks. The web service 110 may be a web service application being hosted and executed at the web server 105 to provide a service over the network 115. The network 115 may include, but is not limited to, a Local Area Network (LAN), a Wide Area Network (WAN), and a Metropolitan Area Network (MAN). Further, the network 115 is representative of a wireless network, a wired network, or a combination thereof.

The network 115 is associated with one or more user devices 120-1, 120-2, 120-3, . . . , 120-N, collectively called as user devices 120. The user devices 120 may include one or more of PDAs, desktops, workstations, servers, etc. In an exemplary implementation, the user devices 120 interact with the web service 110 to place one or more service request. Upon receipt of a service request, the web server 105 accesses an application database 125 that stores one or more web based applications to support different types of service requests.

The application database 125 includes a web based application 130 that manages schedules for a user associated with, for example, the user device 120-1. Although, the web application 130 has been shown as being stored in the application database 125, it may be appreciated that the web application 130 can be stored in the web server 105 and executed therein.

The user device 120-1 includes a schedule organizer 135 that enables the user device 120-1 to organize schedules based on a user input. The schedule organizer 135 along with various other modules facilitates managing of schedules using shared web calendars. A schedule can be managed by sharing a web calendar representing an availability status of a user. In particular, the user may select some dates in a web calendar and block them for one or more events and may also include schedule details relevant to each of the events, such as, venue, etc.

In an exemplary implementation, the schedule organizer 135 presents a calendar to the user to indicate an availability status of the user to one or more recipients. An availability status of a user indicates time slots in a day in the calendar during which the user is available. The availability status can be indicated by selecting date(s) in the calendar presented by the schedule organizer 135 and filling of the schedule details corresponding to events. The selected dates correspond to days and time slots in a day when the user is available for a particular event. Such availability status can be shared with one or more recipients associated with one or more events. A recipient may propose to the user a schedule (a day and a time slot) for an event based on the availability status.

Typically, network based mail applications that may be installed on the user devices 120 provide for a calendar and a contact list associated with a particular user. Such a calendar indicates schedules for one or more events on a specific date and a time slot. A user of the user device 120-1 can import such schedule details from the mail application calendar to the calendar presented by the schedule organizer 135. This enables the user to mark his/her availability status keeping in view the already scheduled events as per the network based mail application calendar.

Also, the user can select one or more recipients from the contact list provided by the network based mail application while marking availability status on a calendar presented by the schedule organizer 135.

In yet another embodiment, the user device 120-1 may be configured to selectively share portions of a web calendar, representing an availability status of the user, with one or more recipients. For purpose of exemplary illustration, portions of a web calendar may refer to an availability status associated with a particular event. Selective sharing of a web calendar facilitates the user to maintain confidentiality of his/her schedules. Also, the user may wish to share the web calendar with his/her contacts or recipients on a need to know basis.

By way of example, a web calendar as received by a particular recipient includes only those selected portions of the availability status of a user that correspond to an event associated with the particular recipient. Conversely, it may be noted that a portion marked by a user of the user device 120-1 for an event associated with a first recipient is not available to a second recipient and so on. However, the same portion may be shared with multiple recipients upon the user's discretion. This is accomplished by selecting multiple recipients prior to publishing of the availability status of the user for a corresponding event.

In yet another implementation, the schedule organizer 135 enables creation of one or more schedules based on an input from a user. The schedules correspond to one or more events associated with the user. A schedule(s) can be created by blocking specific date(s), time, etc. for an event and filling event details in the calendar presented by the schedule organizer 135. The user may share the created schedule with a recipient thereby proposing a schedule for an associated event. It may be appreciated that a recipient may be an individual or a group of individuals associated with computing devices, for example, user device 120-2, 120-3, . . . , 120-N, communicating through the network 115.

Once the availability status of the user is indicated in the calendar, the user can publish the calendar to make it available to one or more recipients. Likewise, the user can share a calendar that includes already created schedules with one or more recipients. In practice, the user device 120-1 places a service request with the web service 110 in order to share the calendar.

The web service 110, on receipt of the service request from the user device 120-1, invokes the web based application 130 stored in the application database 125. In an implementation, the web service 110 and the web based application 130 may be integrated to represent a single entity hosted at the web server 105. In such an implementation, the functionalities of both the web service 110 and the web based application 130 would be provided by the single entity hosted in the web server 110. The web based application 130, upon execution, creates a web calendar that can be presented to one or more recipients. The web calendar refers to a calendar stored in the application database 125 that is available online to any user or recipient who has registered/subscribed to the web service 110.

The web based application 130 synchronizes the calendar presented by the schedule organizer 135 with the web calendar stored in the application database 125. The synchronization enables the user to publish his/her availability status onto the web calendar. The web calendar, which has the availability status of the user, is shared with one or more recipients to manage schedules of the user. It may be appreciated that the user of the user device 120-1 will have to subscribe to the web service 110 to share schedule details through web calendars. Such subscription may be of one or more types depending upon the number of recipients the user wishes to share his/her availability status or schedules with.

On the event of publishing the calendar by the user, a request is sent to the selected recipient(s). The request includes a web link to view the web calendar that has the user's availability status and other relevant details. The recipients can view the web calendar by following the web link.

In an exemplary embodiment, the recipient signs up to the web service 110 to view the web calendar. The web service 110 allows the web based application 130 to provide for authentication details to the recipient. The recipient, upon successful sign up or log in gains access to the web calendar hosted by the web server 105 indicating the availability status of a user of the user device 120-1.

The recipients, upon gaining access, can select a particular day and a time slot based on the availability status published in the web calendar. Alternatively, the recipient can select two or more days to indicate his/her availability for the event corresponding to the availability status. Upon selection of one or more days in the web calendar, the recipient sends a schedule request to the user with the selected (proposed) date and time with relevant event details.

The web service 110 receives such a schedule request, based on which, the web calendar stored in the application database 125 is updated to indicate the days and the time slots selected by the recipient. In a successive progression, the web based application 130 prompts the web service 110 to send the user of the user device 120-1 a notification with a web link to view the updated web calendar. The notification informs the user about the schedule request sent by the recipient. The user follows the link to view the updated web calendar and may either accept or reject the schedule request.

In case of rejection, the user may prompt the recipient to propose a different date and time slot in the web calendar in the same manner as described above. The web service 110 automatically sends a notification to the recipient informing about the user's acceptance or rejection of the schedule request. Again, the notification includes the web link and the recipient gains access to the web calendar in the same manner as described earlier.

The recipient would continue sending schedule requests till a final schedule is agreed upon. When a final schedule for an event is confirmed, the schedule organizer 135 updates the calendar, provided by the network based mail application, with schedule details (day and time slot) corresponding to the final schedule.

### An Exemplary User Device

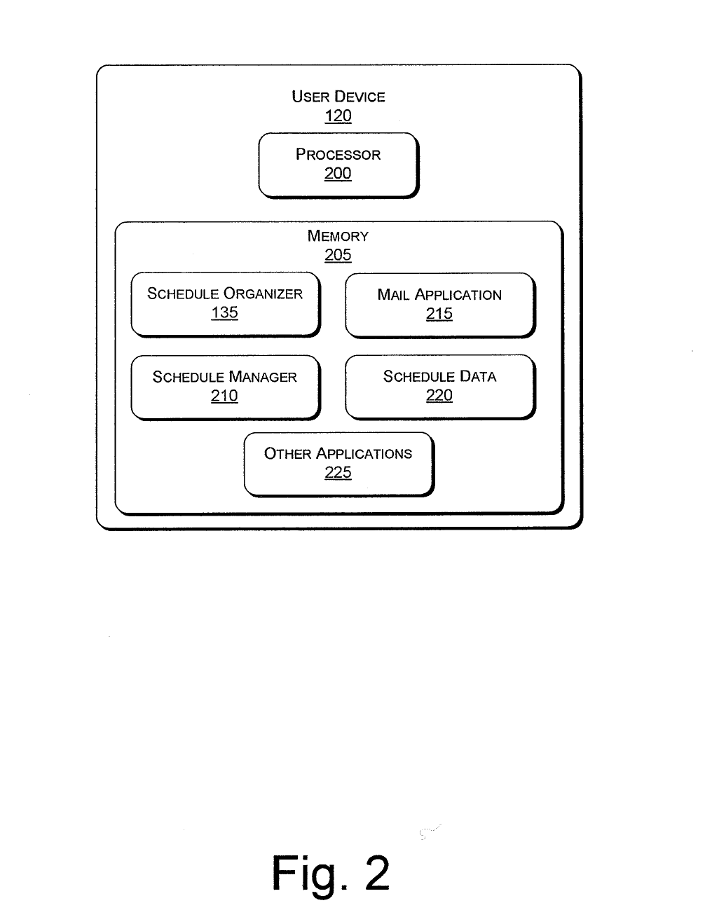

FIG. 2 illustrates an exemplary user device 120 for managing schedules using shared web calendars. In an implementation, the user device 120 includes one or more processor(s) 200 coupled to a memory 205. The processor(s) 200 includes, for example, microprocessors, microcomputers, microcontrollers, digital signal processors, central processing units, state machines, logic circuitries, and/or any devices that manipulate data based on operational instructions. The processors are configured to fetch and execute computer-program instructions stored in memory 205. Such memory 205 includes, for example, one or more volatile memory (e.g., RAM) and non-volatile memory (e.g., ROM, Flash, etc.).

Memory 205 includes one or more modules configured to manage schedules using shared web calendars. A single processor 200 fetches and executes computer program instructions from respective ones of the modules. In an implementation, the modules include the schedule organizer 135, a schedule manager 210, a mail application 215, schedule data 220, and other related applications 225.

The schedule organizer 135 may be similar to an organizer in MS Office Outlook provided by Microsoft® Corporation, headquartered at Redmond, Wash. In an exemplary implementation, the schedule organizer 135 presents a calendar to a user of the user device 120-1 to enable the user to mark his/her availability status. The schedule organizer 135 is also configured to import into the calendar, based on the user's input, details about already finalized schedules from a local calendar provided by a network based mail application (e.g. mail application 215). The calendar presented by the schedule organizer 135 indicates the free/available time and day in accordance with the user's local calendar provided by the mail application 215.

The user selects one or more days and marks them as available for a particular event. The schedule organizer 135 retrieves contacts from a contact list provided by the mail application 215 and presents the contacts to the user. In an implementation, the schedule organizer 135 enables the user to form groups of contacts. Therefore, the user selects one or more contacts or recipients and marks an availability status (corresponding to an event) in the calendar presented by the schedule organizer 135. Once the availability status of the user is marked, the schedule organizer 135 saves the calendar with the availability status in the schedule data 220. The schedule organizer 135 may also include a functionality to set reminders for the events that are marked in it. Successively, the user invokes the schedule manager 210 to publish the saved calendar so that the availability status can be made available to one or more recipients selected by the user.

The schedule manager 210 sends a service request to the web service 110 in order to publish the availability status of the user as saved in the schedule data 220. Upon receipt of such a request, the web service 110 invokes the web based application 130 to create a web calendar corresponding to the user. In an embodiment, the web service 110 and the web application 130 may be integrated to form a single entity stored in the web server 105. In such an embodiment, the single entity would provide functionalities of the web application 130 and the web service 110. The schedule manager 210 sends the availability status of the user to the web based application 130. The web based application 130 publishes the availability status of the user in the web calendar. The web calendar is made available to one or more recipients. In one implementation, the schedule manager 210 sends a request to the web service 110 to synchronize the time zone of the user of the user device 120-1 and one or more recipients.

The schedule manager 210 also receives a notification from the web service 110 informing the user about a schedule request send by a recipient. As indicated earlier, the user views the updated web calendar with selected days and time slots as proposed by the recipient to either accept or reject the schedule request. In either of the cases, the schedule manager 210 accesses the web calendar through the web service 110. Further, the schedule manager 210 sends an acceptance or rejection message from the user device 120-1 to the recipient.

In another implementation, the schedule manager 210 may be configured to enable the user of the user device 120-1 to share web calendar with the recipient based on certain access rights such as standard access and limited access. For purpose of exemplary illustration, standard access refers to a long term subscription of the web service 110 by the recipient. Typically, a standard access is given to a recipient with whom the user wants to share availability information very frequently. On the other hand, a limited access refers to a short term access given to a recipient. For example, the user may share the web calendar with a recipient for 7 days or 15 days. In such a case, the recipient has a limited subscription for the limited period.

The mail application 215 provides a platform to manage schedules using shared web calendars. In particular, the mail application 215 provides for a calendar and a contact list to enable the user to publish and selectively share the user's availability status. In an alternative embodiment, the schedule organizer 135 and the schedule manager 210 may be integrated with the mail application 215. In such an embodiment, the functionalities of the schedule organizer 135 and the schedule manager 210 will be presented as additional features of the mail application 215. The other related applications 225 may include various modules required for the functioning of the user devices 120 such as an operating system, application software, etc.

### An Exemplary Application Database

In an exemplary implementation, the web server 105 hosts the web based application 130 to support the service requests from the user devices 120. As discussed earlier, the user devices 120 subscribes to the web service 110 and gains access to the web server 105 to execute the web application 130. To this end, the application database 125 stores the web based application 130, a web calendar 305, and web schedule data 310.

The web service 110 receives service request from the user device 120-1. Upon receipt of the request, the web based application 130 creates and maintains the web calendar 305. The web calendar 305 indicates an availability status of a user of the user device 120-1. The web based application 130 also stores scheduled details and details associated with the recipients of the user's availability status in the web schedule data 310.

Furthermore, the web based application 130 includes various other modules that facilitate management of schedules using shared web calendars. In an implementation, the web based application 130 includes a synchronization module 315, an authentication module 320, an updating module 325, and user data 330.

The synchronization module 315 synchronizes the web calendar 305 with a calendar associated with the schedule organizer 135 in the user device 120-1. The synchronization can be triggered by, for example, a request from the user device 120-1, a schedule request from the recipient. The synchronization module 315 also synchronizes the web calendar 305 with a local calendar provided by the mail application 215 when a schedule for an event is finalized.

In an alternative embodiment, the synchronization module 315 can synchronize the web calendar 305 to reflect a time zone variation between the user device 120-1 and any other user device, for example, 120-2, 120-3, etc., being used by a recipient. To substantiate, the synchronization module 315 takes into account any time differences due to different geographical locations of the user and the recipients respectively. For example, a user of the user device 120-1 located in India may organize schedules in a calendar presented by the schedule organizer 135 based on Indian Standard Time (IST). Now if the recipient is located in the U.S, the synchronization module 315 takes into consideration the time lag between the IST and local time zone (e.g. Pacific Standard Time (PST)) and marks the availability status in the web calendar 305 in accordance with the local time zone. Therefore, the recipient views the availability status as per the local time zone of the US.

The authentication module 320 enables the recipient to sign in to the web service 110. The schedule manager 210 sends details associated with one or more recipients as selected by the user. As discussed earlier, the schedule manager 210 provides two types of accesses: standard access and limited access. The authentication module 320 checks whether a recipient has been given a standard access or limited access to the web calendar 305. In case of a standard access, the authentication module 320 provides a username and a password to the recipient and manages the access provided to the recipient. In case of limited access, the authentication module 320 can verify the access rights of the recipient based on a predetermined time specified by the user. The authentication module 320 stores the details associated with the recipient in user data 330.

The updating module 325 updates the web schedule data 310 with schedule requests exchanged between the user and the recipient. In addition, the updating module 325 updates the web calendar 305 to indicate the days and time slots selected by the recipient.

### An Exemplary Method

Method for managing schedules using shared web calendars can be described in the general context of computer executable instructions. Generally, computer executable instructions includes routines, programs, objects, components, data structures, procedures, modules, functions, and the like that perform particular functions or implement particular abstract data types.

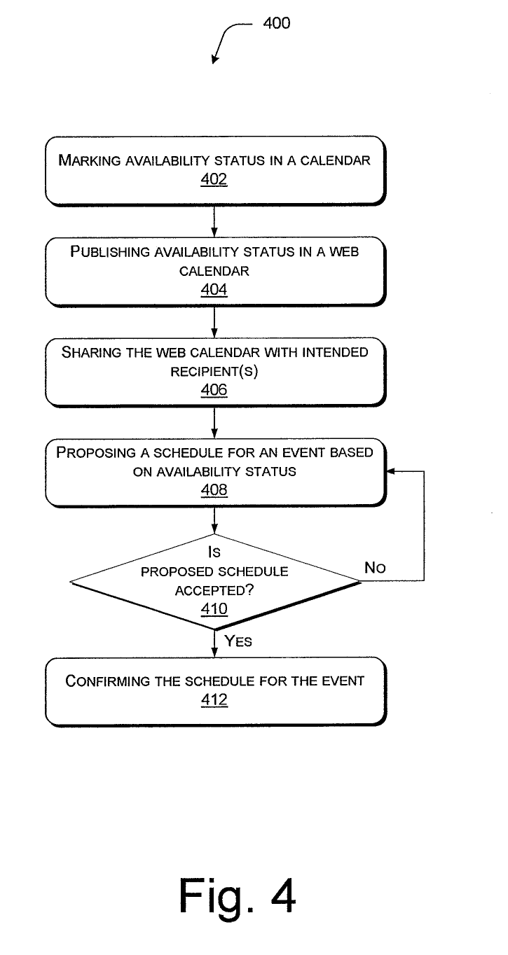

FIG. 4, illustrating an exemplary method 400 for managing schedules using a shared web calendars, is described with reference to the exemplary system 100. The order in which the method is described is not intended to be construed as a limitation, and any number of the described method blocks can be combined in any order to implement the method, or an alternative method.

At block 402, available status of a user is marked in a calendar. In an implementation, the schedule organizer 135 presents a calendar to a user of the user device 120-1. The user indicates his/her availability status in the calendar by marking available time slots or days on which the user is available. The user also selects one or more recipients with whom the user intends to share such availability status.

At block 404, the availability status of the user is published in a web calendar. The web based application 130, upon receiving a service request from the user device 120-1, creates a web calendar 305 that includes the availability status of the user of the user device 120-1. The web calendar 305 is stored in the application database 125 and can be accessed and viewed by a recipient. In an implementation, publishing includes hosting the web calendar in the web server 105. The publishing may also include synchronizing the web calendar 305 with a local calendar associated with a network based mail application 215.

At block 406, the web calendar is shared with recipient(s) such that each of the recipients views a selected portion of the availability status in the web calendar. In an implementation, the user of the user device 120-1 selects one or more recipients to share the availability status for a particular event. The availability status of the user corresponding to the event is a portion of the user's overall availability status in the web calendar 305. For example, the user's availability status for a second event (a portion of the user's overall availability status) will be selectively shared with a different set of recipients and so on.

In an alternative embodiment, sharing the web calendar 305 further includes providing for two types of accesses to a recipient namely: a standard access and a limited access. In case of a standard access, a recipient registers to the web service 110 to gain access to the web calendar 305. The authentication module 320 provides a user name and a password to the recipient after the registration process. The authentication module 320 authenticates the username and password and may verify other credentials of the recipient to provide access to the web calendar 305 during a subsequent access by the recipient. In case of a limited access, the web calendar 305 is made available to a recipient for a pre-determined number of days. The user selects one of the two access types for a recipient when the user marks the availability status for the recipient.

At block 408, a schedule is proposed for an event based on the availability status in the web calendar. In an implementation, a recipient proposes a schedule for an event by selecting a day and a time slot in the web calendar based on the availability status of the user. The recipient then sends a schedule request to the user with the proposed schedule (selected day and time) for the event.

At block 410, a determination is made whether or not the proposed schedule is accepted. If the proposed schedule is accepted, then block 412 is executed else block 408 is executed. As discussed earlier, the user of the device 102-1 may either accept or reject the schedule proposed by the recipient. If the user rejects the proposed schedule, the user may prompt the recipient to send a revised schedule request with a proposed schedule (day, time slot etc.).

At block 412, if the proposed schedule is accepted, the schedule for the event is confirmed by sending a confirmation email or a message.

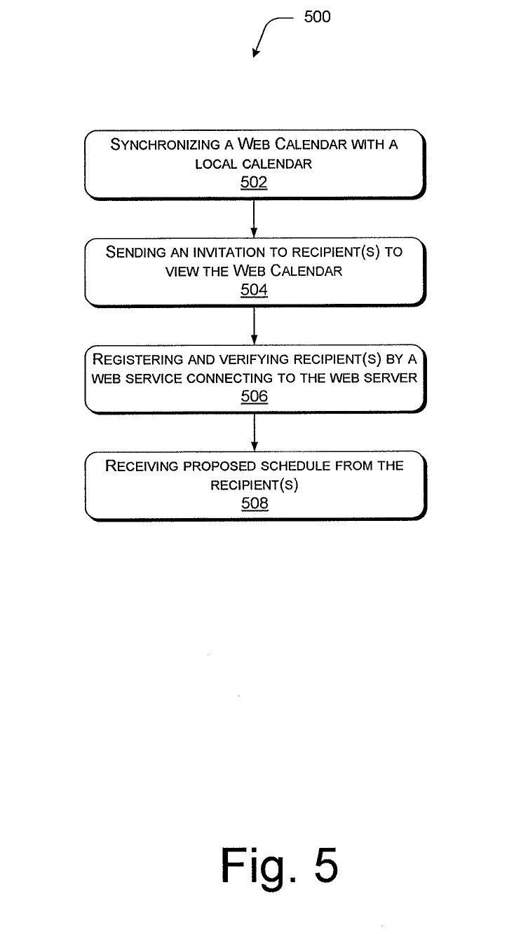

FIG. 5 illustrates an interaction of a user device (e.g. user device 120-1) with the web server 105. In an exemplary implementation, at block 502, the web calendar 305 is synchronized with the local calendar associated with the schedule organizer 135. This ensures consistency of the schedule details for an event, such as, day, time, venue details, etc.

At block 504, an invitation is sent to recipients to view the web calendar 305. In an implementation, schedule manager 210 sends an invitation to one or more contacts, stored in the address book (contact list) of the mail application 215, to view the web calendar 305.

At block 506, the recipients are registered and/or verified by the authentication module 320. In an implementation, the recipients may have either of a standard access or limited access to the web calendar 305. Credentials of the recipients are verified before giving access to the web calendar 305. There may be recipients who are accessing the web calendar 305 for the very first time; they can be registered with the web service 110 to manage subsequent accesses.

At block 508, a proposed schedule is received from the recipient. The recipient accesses the web calendar 305 and views an availability status of a user. Based on the availability status, the recipient selects a day and time slot in the web calendar 305 and sends a schedule request with a proposed schedule for an event.

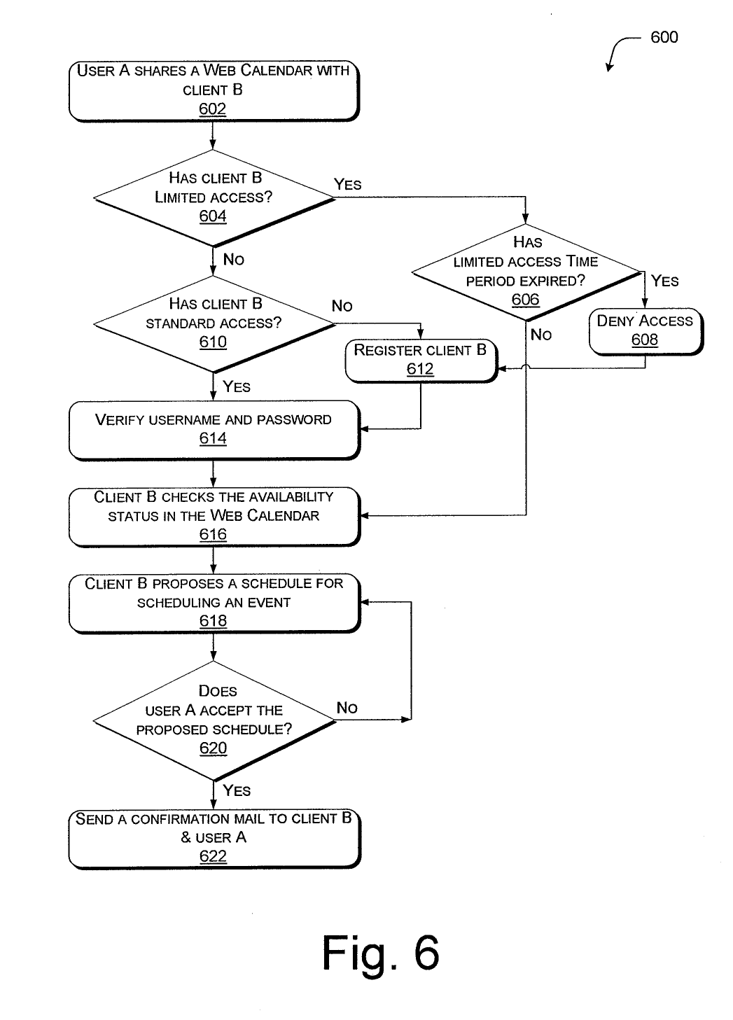

FIG. 6 illustrates an exemplary method for scheduling an event using a shared web calendar between a user and a client (recipient). At block 602, user A shares a portion of his/her availability status with client B using the web calendar 305. The web calendar 305 may be marked with available days and time slots that are meant for an event associated with client B. Client B can have certain access rights for accessing the web calendar 305 such as standard access or limited access.

At block 604, it is determined whether client B has a limited access or not. If client B has limited access then, at block 606, it is determined whether the time period associated with the limited access has expired or not. In limited access, the access to the web calendar 305 is limited to a pre-determined time period, for example, one week, 15 days, etc. based upon a user input. If the time period associated with the limited access has expired then, at block 608, the access to the web calendar 305 is denied, and, at block 612, client B may be prompted to register again with the web service 110 for gaining access rights for the web calendar 305. If the time period for the limited access has not expired then, at block 616, client B gains access to the web calendar 305 and view the availability status of user A in the web calendar 305.

At block 604, if client B does not have limited access then, at block 610, it is determined whether client B has a standard access. If client B does not have a standard access, client B can be asked to register with the web service 110 for gaining access to the web calendar 305. If client B has standard access then, at block 614, username and password as entered by client B are verified. At block 616, client B gains access to the web calendar 305 and can view the availability status of user A in the web calendar 305.

At block 618, client B proposes a time slot for scheduling an event. Client B can look for an available day and time slot in the web calendar 305 that suits his or her schedule. Client B marks a day and a time slot in the web calendar 305 and proposes a schedule for the event to user A. The proposal may also include other details such as the type of event, venue, etc. along with the date and time in the web calendar 305.

At block 620, it is determined whether user A has accepted the schedule proposed by client B. If user A does not accept the proposed schedule then, user A may prompt client B to suggest an alternate schedule (day and time slot) for the event according to his or her convenience. Hence, block 618 is executed. On the other hand, if user A accepts the proposed schedule then, at block 622, a confirmation mail is sent to user A and client B.

### CONCLUSION

The above-described methods and systems describe managing schedules using shared web calendars. Although the subject matter has been described in language specific to structural features and/or methodological acts, it is to be understood that the invention defined in the appended claim is not necessarily limited to the specific features or acts described. Rather, the specific features and acts are disclosed as exemplary forms of implementing the claimed subject matter.

I/We claim:

1. A method comprising:
publishing an availability status of a user in a web calendar; and
sharing the web calendar with one or more recipients such that each of the one or more recipients views a selected portion of the availability status in the web calendar.

2. The method as recited in claim 1, wherein the availability status indicates time slots in a day during which the user is available.

3. The method as recited in claim 1, wherein the publishing comprises hosting the web calendar at a server.

4. The method as recited in claim 1, wherein the publishing comprises synchronizing the web calendar with a local calendar associated with a network based mail application.

5. The method as recited in claim 1, wherein the sharing comprises registering to a web service that provides a username and a password to the one or more recipients for gaining access to the web calendar.

6. The method as recited in claim 1, wherein the sharing comprises:
proposing a schedule for an event based on the availability status in the web calendar.

7. The method as recited in claim 6, wherein the proposing comprises selecting a day and a time slot in the web calendar.

8. The method as recited in claim 6 further comprising accepting or rejecting the proposed schedule.

9. The method as recited in claim 1, wherein the sharing comprises making the web calendar available to the one or more recipients for a predetermined number of days.

10. One or more computer readable medium comprising computer executable instructions for:
sending an invitation to a recipient to view a web calendar representing an availability status of a user for an event; and
receiving a proposed schedule for the event from the recipient based on the availability status.

11. One or more computer readable medium as recited in claim 10, wherein the availability status indicates time slots in a day during which the user is available.

12. One or more computer readable medium as recited in claim 10, wherein the sending comprises providing a username and a password to the recipient for gaining access to the web calendar.

13. One or more computer readable medium as recited in claim 10, wherein the proposed schedule comprises a day, a time slot in the web calendar and description of the event.

14. A system comprising:
a processor;
a memory;
a schedule organizer configured to represent an availability status of a user in a web calendar; and
a schedule manager configured to share the web calendar with a plurality of recipients such that each of the plurality of recipient views a selected portion of the availability status on the web calendar.

15. The system as recited in claim 14, wherein the availability status indicates time slots in a day during which the user is available.

16. The system as recited in claim 14, wherein the schedule organizer synchronizes the web calendar with a local calendar associated with a network based mail application.

17. The system as recited in claim 14, wherein the schedule manager enables hosting of the web calendar at a server.

18. The system as recited in claim 14, wherein the schedule manager synchronizes a user time zone in the web calendar with a time zone of the recipients.

19. The system as recited in claim 14, wherein the schedule manager receives a proposed schedule from one or more of the plurality of recipients.

20. The system as recited in claim 19, wherein the schedule manager accepts or rejects the proposed schedule based on an input from the user.
